(19) United States
(12) Patent Application Publication
(10) Pub. No.: US 2020/0079138 A1
(43) Pub. Date: Mar. 12, 2020

(54) RESEALABLE WET OR DRY APPLICATION ROLLER APPARATUS CONTAINER WITH OPTIONAL DISPOSABLE LINER INSERT

(71) Applicant: Craig Stephen Quinn, North Lauderdale, FL (US)

(72) Inventor: Craig Stephen Quinn, North Lauderdale, FL (US)

(21) Appl. No.: 16/364,110

(22) Filed: Mar. 25, 2019

Related U.S. Application Data
(63) Continuation of application No. 62/728,237, filed on Sep. 7, 2018.

(51) Int. Cl. B44D 3/12

(52) U.S. Cl. CPC B44D 3/125

(57) ABSTRACT

A resealable wet or dry application roller container, with optional disposable insert liner, for the sealed storage and transportation of a wet or dry application roller, either by itself, or while remaining attached to the application roller frame, and after rolling off any excess paint from a wet application roller, and being sealed within container, with, or without, optional disposable insert liner, does not leak regardless of orientation.

### BACKGROUND OF INVENTION

The present invention is in the technical field of painting. More particularly, the present invention is in the technical field of painting application devices. More particularly, the present invention is in the technical field of paint roller applicators. More particularly, the present invention is in the technical field of paint roller applicator accessories

Application rollers utilized in a wet state, cannot be left unutilized in open air for over short periods of time without application products, such as, but not limited to, latex, or oil base products from curing on the roller, and a less desired options, such as, resorting to plastic bags, or even saran/cling wrap, or the like, to attempt to wrap a wet roller, are problematic, as well as application trays for resting application rollers in a wet state, require a flat level surface, and are not easily transportable, and careful handling is required for, but not limited to, the previous examples, or leakages and spillage can occur resulting in undesired spillage, aforementioned product spillage resulting in, but not limited to, damage to any surfaces contacted, other items, and any other objects contacted as a consequence of undesired products such but not limited to latex, or oil base products spillage.

### SUMMARY OF THE INVENTION

The present invention is a resealable wet or dry application roller apparatus container and optional disposable liner insert, for the sealed storage and viable transportation of a wet or dry application roller either by itself or while remaining attached to the application roller frame, and after rolling off any excess paint from a wet application roller, and being sealed within said apparatus container, does not leak regardless of orientation. These and other features, aspects and advantages of the present invention will become better understood with reference to the following drawings, description and claims.

### BRIEF DESCRIPTION OF THE DRAWINGS

FIG. 1 is a perspective line drawing view of the present invention, a resealable wet or dry application roller container with a detachably slotted cap, and lanyard, and slotted container, and optional disposable liner insert inserted;

FIG. 1A is a simplified revision of FIG. 1 for further explanation,

FIG. 1B is a simplified revision of FIG. 1 for further explanation,

FIG. 2 is a line drawing side view of the resealable wet or dry application roller container with, detachably slotted cap, and lanyard, and slotted container, and optional disposable liner insert inserted from FIG. 1;

FIG. 2A is a simplified revision of FIG. 2 for further explanation,

FIG. 2B is a simplified revision of FIG. 2 for further explanation,

FIG. 3 is a perspective zoomed out view of the resealable wet or dry application roller container with, detachably slotted cap, and lanyard, and slotted container, shown before insertion of the, optional disposable insert liner, and the roller, with roller frame attached from FIG. 1;

FIG. 3A is a simplified revision of FIG. 3 for further explanation,

FIG. 3B is a simplified revision of FIG. 3 for further explanation,

FIG. 4 is a perspective view of the resealable wet or dry application roller container with, detachably slotted cap, and lanyard, and slotted container, with an optional disposable liner insert inserted, and application roller with frame inserted, and the detachably slotted cap ready to be attached, from FIG. 1;

FIG. 4A is a simplified revision of FIG. 4 for further explanation,

FIG. 4B is a simplified revision of FIG. 4 for further explanation,

FIG. 5 is a perspective view of the wet or dry application roller container with, detachably slotted cap, and lanyard, and slotted container, with an optional disposable liner insert inserted and application roller with frame inserted, and the detachably slotted cap attached from FIG. 1;

FIG. 5A is a simplified revision of FIG. 5 for further explanation,

FIG. 5B is a simplified revision of FIG. 5 for further explanation,

FIG. 6 is a perspective view of the wet or dry application roller container with, detachably slotted cap, and lanyard, and slotted container, with an optional disposable liner insert inserted and application roller inserted, and the detachably slotted cap attached, however pivotably rotated in such a way as to misalign the slots on the detachably slotted cap and on the slotted container, resulting in a seal, of the application roller without the frame attached from FIG. 1;

FIG. 6A is a simplified revision of FIG. 6 for further explanation,

FIG. 6B is a simplified revision of FIG. 6 for further explanation,

FIG. 7 is a perspective zoomed in view of the wet or dry application roller container with, detachably slotted cap, and lanyard, and slotted container, and without the optional disposable insert from FIG. 1;

FIG. 7A is a simplified revision of FIG. 7 for further explanation,

FIG. 7B is a simplified revision of FIG. 7 for further explanation,

FIG. 8 is a perspective zoomed in view of the optional disposable liner insert from FIG. 1;

FIG. 8A is a simplified revision of FIG. 8 for further explanation,

FIG. 8B is a simplified revision of FIG. 8 for further explanation,

### DETAILED DESCRIPTION OF THE INVENTION

The following detailed description represents the best currently contemplated modes for carrying out the invention. The description is not to be taken in a limiting sense, but is made merely for the purpose of illustrating the general principles of the invention.

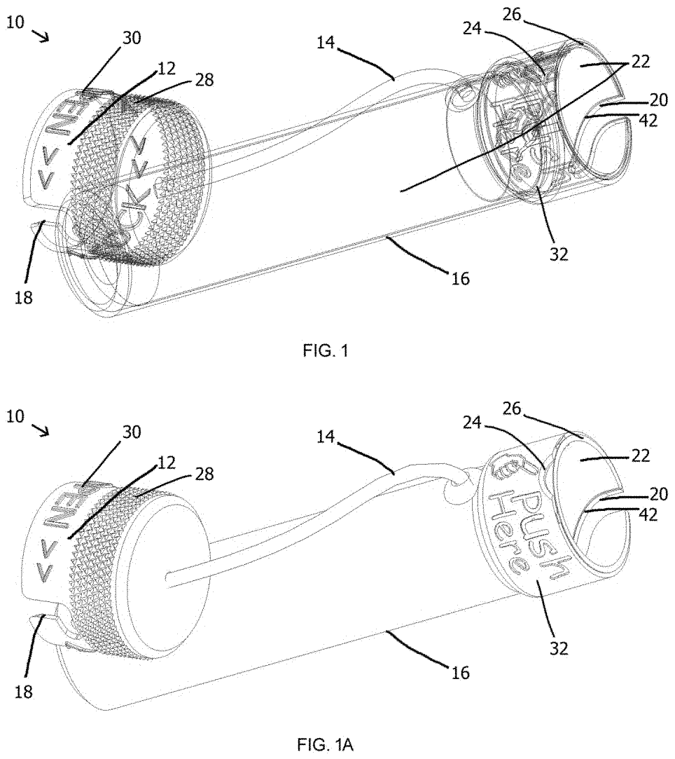

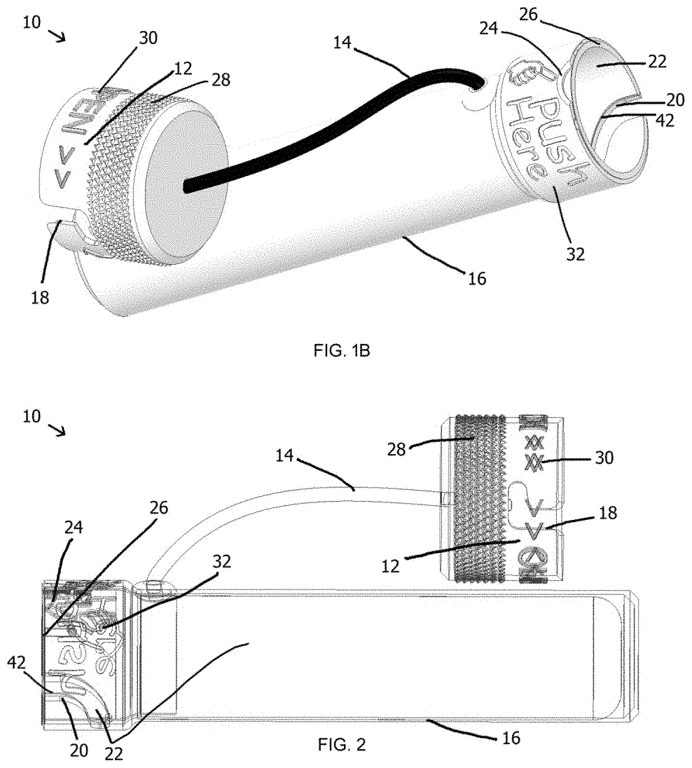

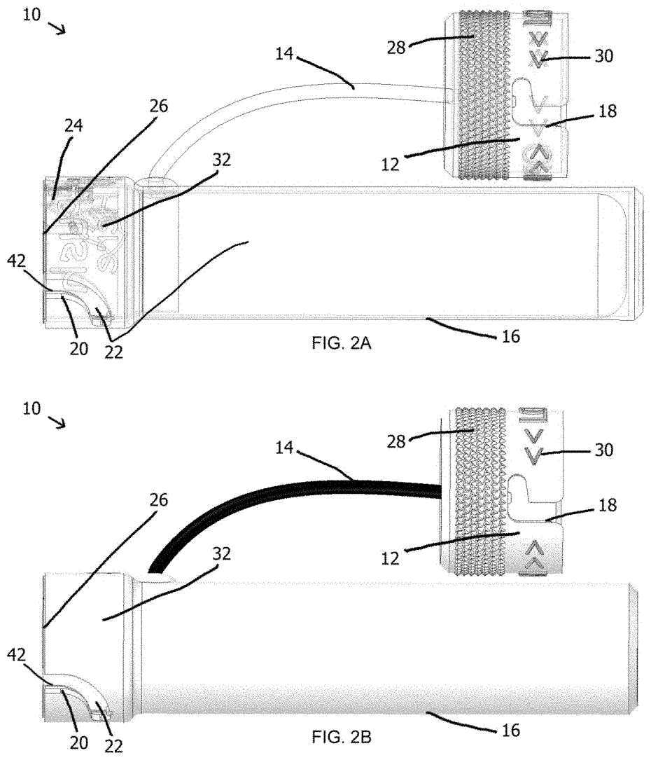

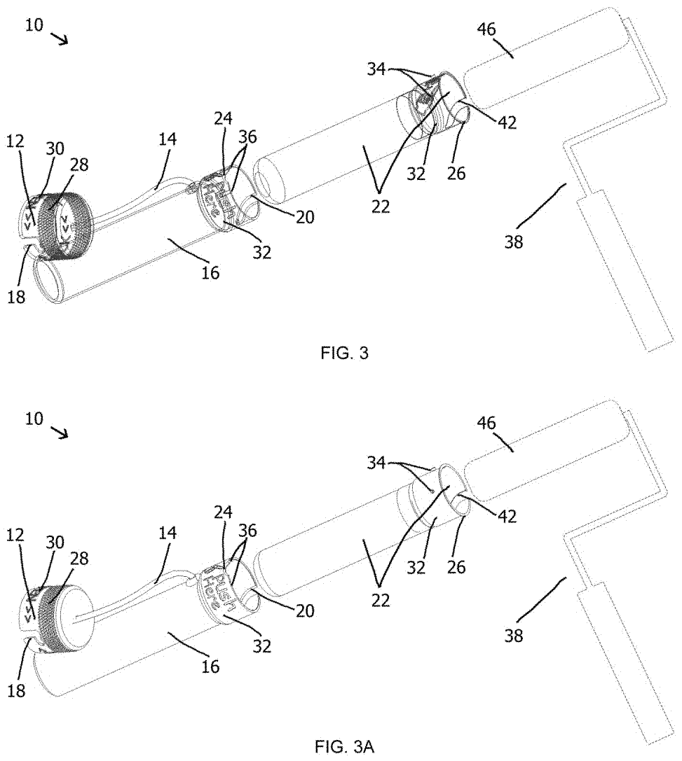

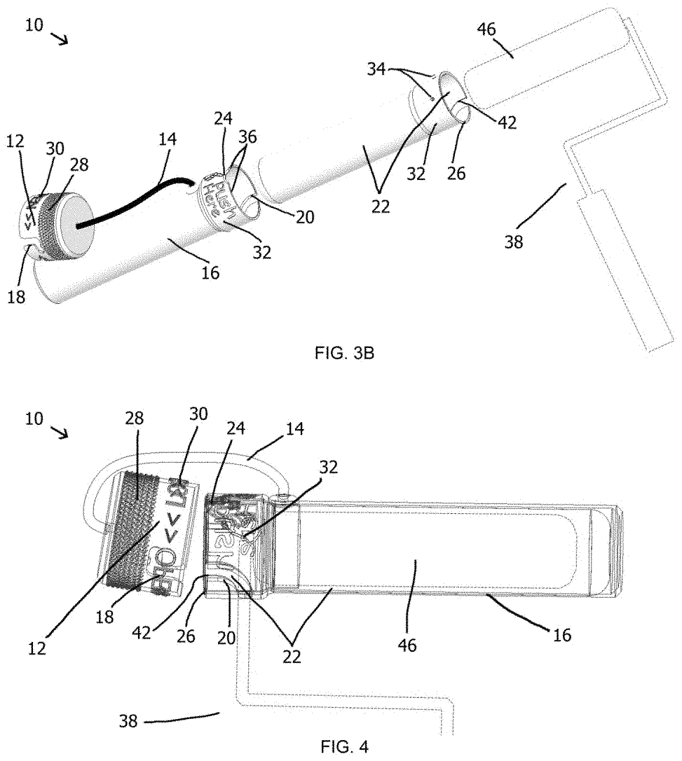

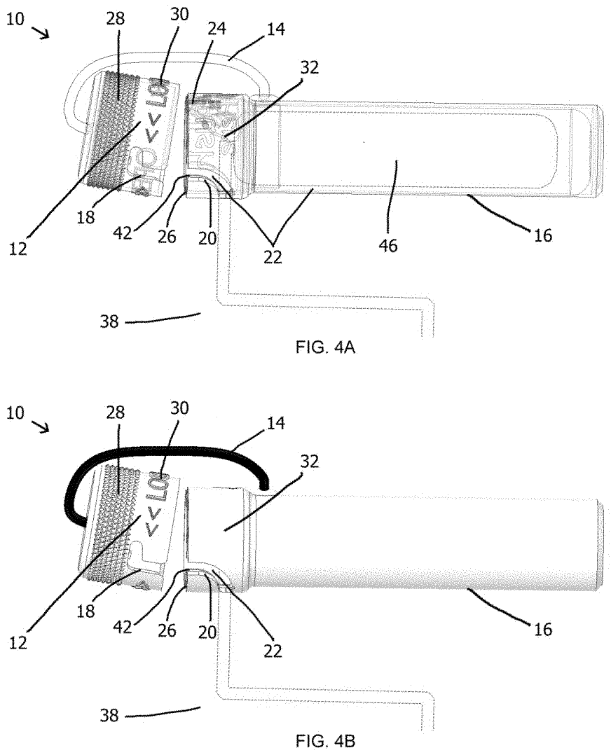

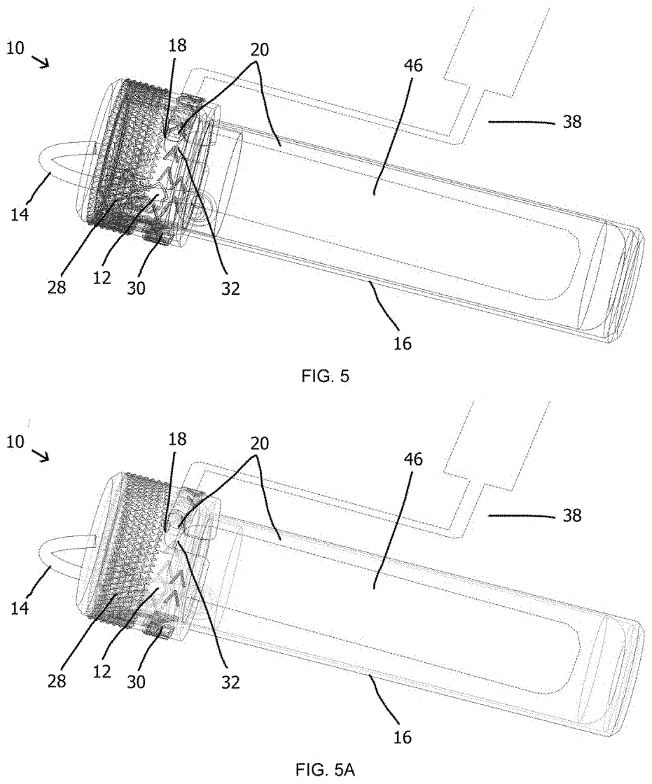

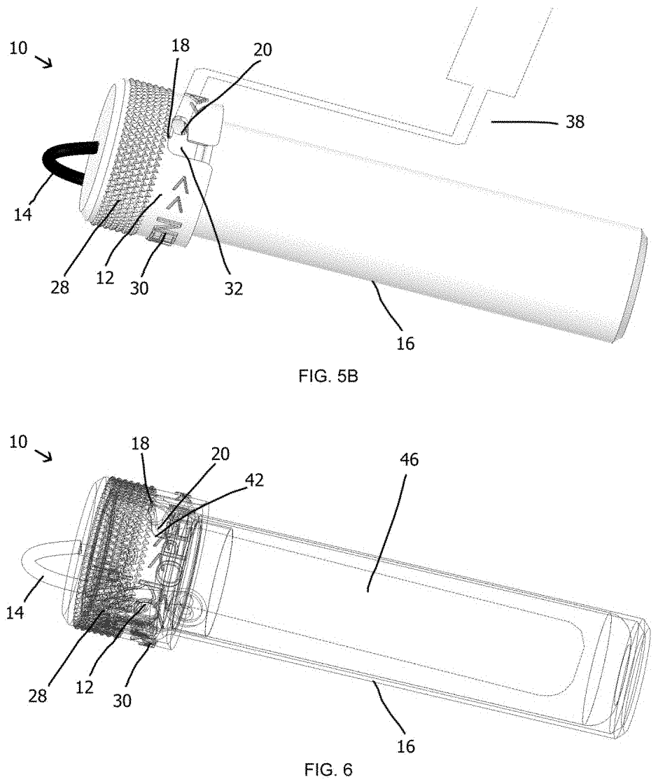

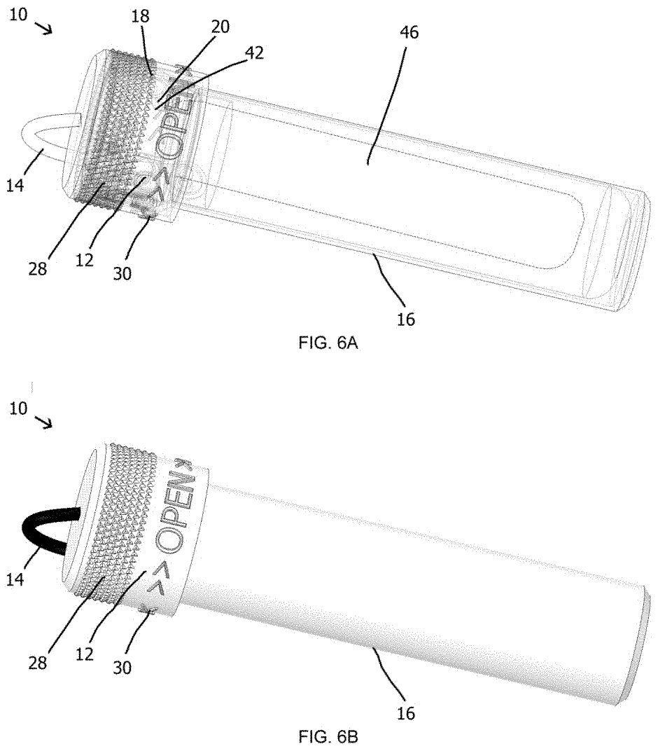

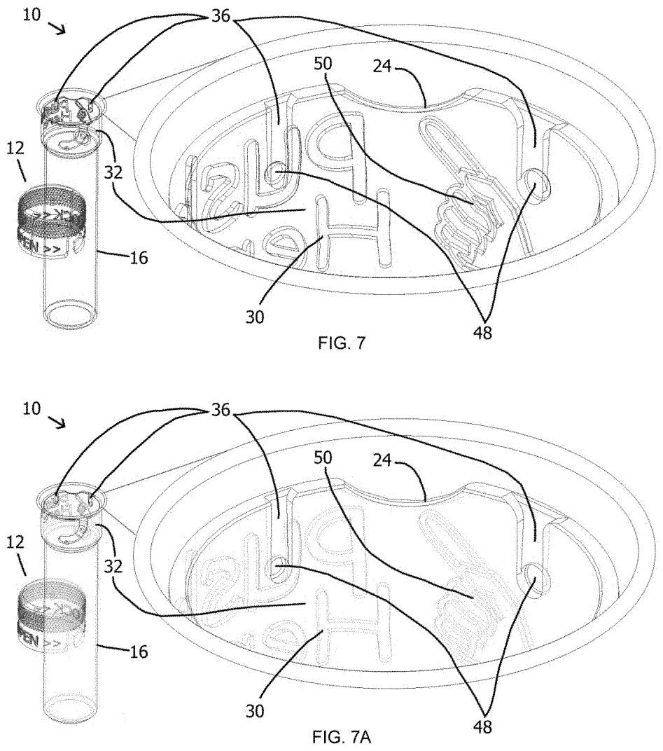

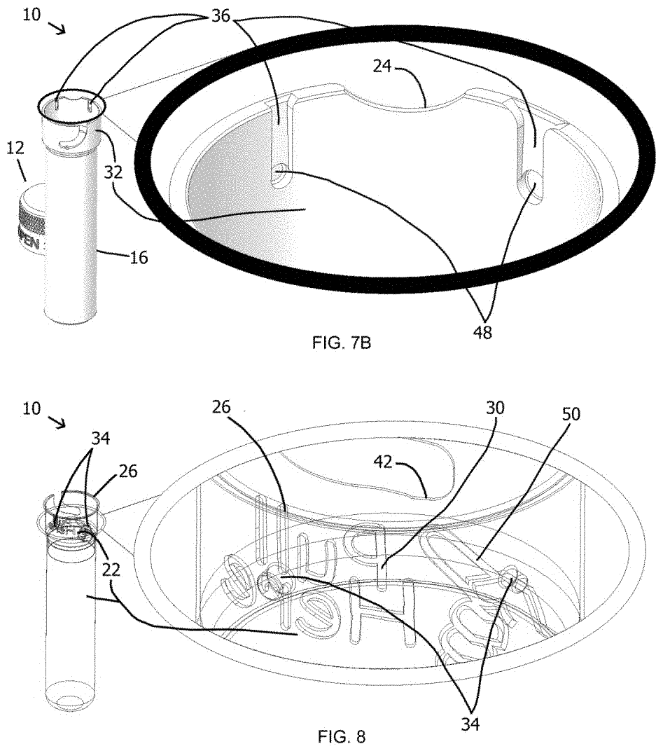

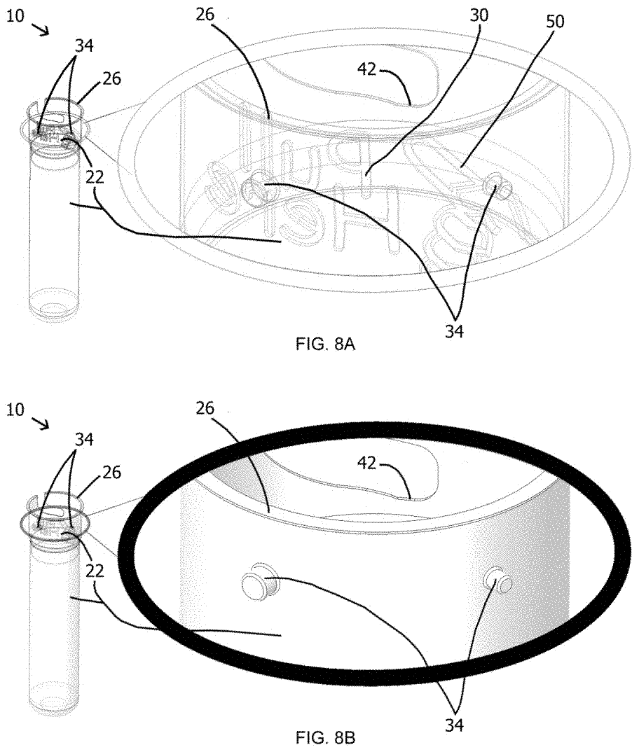

Referring now to the invention in more detail, in FIG. 1, FIG. 2, FIG. 3, FIG. 4, FIG. 5, FIG. 6, there is shown the present invention, a resealable wet or dry application roller apparatus container 10, with optional disposable liner insert 22, for the sealed storage and viable transportation of a wet or dry application roller 46, either by itself, or while remaining attached to the application roller frame 38, and after rolling off any excess paint from a wet application roller 46, and being sealed within said apparatus container 10, with, or without, optional disposable liner insert 22, does not leak regardless of orientation, for up to, but not limited to, 30 days, in the wet state, and indefinitely in the dry state, thus allowing the stopping and starting of product application, without having to clean the application roller 46 for each stop and start iteration, and is comprising of but not limited to a slotted 20, hollow preferably cylindrical member 16, or a hollow square member, or a hollow oval member, or even a hollow octagon member, or even some combination of, said body is closed on one end, and is open and enlarged 32 and slotted 20, but not limited to, straight, curved elbow or any combination of said slot, on the other end, and with the detachably slotted 18 cap 12, with optional raised 3-D knurling 28, and or raised 3-D text 30, and or any graphic 50, to provide extra grip for opening and closing said cap 12, and with the detachably slotted 18 cap 12, said slot may be, but not limited to, straight, curved elbow or any combination of, cap 12, enabling a seal for the open end when attached, said cap 12, can be appended by, but not limited to, a lanyard 14, or even a hinge or the like, the wet or dry application roller container 10, keyway channel(s) 36, is recessed deeper on upper rim side, and recessed shallower on the opposing end of the channel(s) 36 up to the rim of the alignment key(s) 34, socket 48, and provide a semi resistive locking effect for the optional disposable insert liner(s) 22 alignment keys(s) 34, along with stop lip 26, to hold optional disposable liner insert 22, in place, and the concave depression 24, located at the rim of member 16 enlarged 32 open end, is provided to allow finger pressure to dislodge the alignment keys 34, from said semi resistive locking socket 48 for optional disposable liner insert 22 with optional raised 3-D knurling 28, and or raised 3-D text 30, and or any graphic 50, to provide extra grip for removal or for the replacement of optional disposable liner insert 22, and is designed to store a wet or dry application roller 46, by itself, or while remaining attached to the application roller frame 38, for up to, but not limited to, 30 days, in the wet state, and indefinitely in the dry state, thus allowing the stopping and starting of product application without having to clean the application roller 46, for each stop and start iteration.

The construction details of the invention as shown in FIG. 1, FIG. 2, FIG. 3, FIG. 4, FIG. 5, FIG. 6, are that the resealable wet or dry application roller apparatus container 10, with optional disposable liner insert 22, may be made of, but not limited to, or any combination of, sufficiently rigid or flexible material such as high strength plastic, LDPE, HDPE, TPE, plastic alloys, metal, metal alloys, Poly, PET, ABS, Nylon, TPE, silicone, silicone alloys, and the like, further, the various methods of manufacturing can be, but not limited to, blow mold, injection molding 1, 2,even 3, or 4 Shot Molding, optional disposable liner insert 22, may be made to be but not limited to, collapsible so as to lay flat for packaging, however could also be made to be semi rigid at the top and a collapsible lower portion, so as to be stackable, for packaging, or any combination of

1. A resealable wet or dry application roller apparatus container with optional disposable liner insert comprising of:
a detachably slotted cap, appended by, but not limited to, a lanyard, a slotted, hollow preferably but not limited to, cylindrical member, with keyway channel(s) and alignment key(s) socket, and a concave depression, located at the rim of members enlarged open end, an optional disposable insert liner.

2. The apparatus as in claim 1 wherein said keyway channel(s) recessed deeper at the rim of members enlarged open end, and recessed shallower on the opposing end of the channel(s) up to the rim of the alignment key(s) socket, and provide a semi resistive locking effect for the optional disposable insert liners alignment keys(s).

3. The apparatus as in claim 1 wherein said hollow cylindrical members slot, but not limited to, straight, curved elbow or any combination of said slot.

4. The apparatus as in claim 1 wherein said detachably slotted, but not limited to, straight, curved elbow or any combination of said slot, cap, with optional raised 3-D knurling and or raised 3-D text and or any graphic, to provide extra grip for opening and closing.

5. The apparatus as in claim 1 wherein said, a concave depression, located at the rim of members enlarged open end provide a finger pull to dislodge and release the optional disposable insert liner.

6. The apparatus as in claim 1 wherein said, an optional disposable insert liner, with alignment keys, along with stop lip, hold the optional disposable liner insert, in place, finger pressure will dislodge the alignment keys, from semi resistive locking socket for optional disposable liner insert with optional raised 3-D knurling, and or raised 3-D text, and or any graphic, to provide extra grip for removal or for the replacement of optional disposable insert liner.

7. The apparatus as in claim 1 wherein said resealable wet or dry application roller apparatus container with optional disposable liner insert for the sealed storage and viable transportation of a wet or dry application roller, either by itself, or while remaining attached to the application roller frame, and after rolling off any excess paint from a wet application roller, and being sealed within said apparatus container, with, or without, optional disposable liner insert, does not leak regardless of orientation, for up to, but not limited to, 30 days, in the wet state, and indefinitely in the dry state.
